(19) United States
(12) Patent Application Publication
(10) Pub. No.: US 2012/0249879 A1
(43) Pub. Date: Oct. 4, 2012

(54) METHOD FOR ELIMINATING SUBTITLES OF A VIDEO PROGRAM, AND ASSOCIATED VIDEO DISPLAY SYSTEM

(76) Inventor: Yan-Wei Yuan, Hefei (CN)

(21) Appl. No.: 12/918,816

(22) PCT Filed: May 14, 2010
(86) PCT No.: PCT/CN2010/072783

§ 371 Date: Aug. 22, 2010

(51) Int. Cl. H04N 9/64; G11B 27/00

(52) U.S. Cl. 348/577; 386/278; 348/E09.037; 386/E05.028

(57) ABSTRACT

A method for eliminating subtitles of a video program is provided, where each of the subtitles is originally stored as a portion of an image of the video program. The method includes: detecting whether a sub-region of a specific color exists within a predetermined region on the image, in order to determine whether a subtitle exists; and when it is detected that the subtitle exists, changing at least one color within the predetermined region to eliminate the subtitle. An associated video display system is also provided.

### TECHNICAL FIELD

The present invention relates to subtitle elimination of a video program, and more particularly, to a method for eliminating subtitles of a video program, and to an associated video display system.

### BACKGROUND

According to the related art, a conventional video display system such as a conventional Digital Versatile Disc (DVD) player can enable/disable subtitle display or select subtitles of a specific language, for being displayed on a screen, given that subtitle data is typically stored separately. Taking a conventional digital television (TV) or a conventional digital TV receiver as another example of the conventional video display system, the conventional digital TV or the conventional digital TV receiver is also capable of enabling/disabling subtitle display since a subtitle data stream is typically available. However, in a situation where a subtitle is originally stored as a portion of an image of a video program, some problems may occur, and it seems unlikely that the related art can handle the situation properly.

For example, when a user is viewing a TV program that is played back with a language that is not his/her own native language, the user may rely on subtitles of the TV program to understand the conversations in the TV program. Sometimes the subtitles are not clearly displayed. Although the TV program can be broadcasted digitally, when the subtitles are originally stored with an image format, the display quality of the subtitles may still be unqualified due to various reasons. As a result, the user may try to utilize a remote controller of the conventional digital TV or the conventional digital TV receiver to disable subtitle display, but it does not work, giving the user a bad viewing experience.

In another example, when a user is viewing a TV program that is played back with a language that is not his/her own native language, the user may try to understand the conversations in the TV program without relying on subtitles of the TV program, in order to learn the language during viewing the TV program. Although the TV program can be broadcasted digitally, when the subtitles are originally stored with an image format, the user still cannot utilize the remote controller of the conventional digital TV or the conventional digital TV receiver to disable subtitle display, giving the user a bad viewing experience.

Please note that the conventional video display system does not serve the user well. Thus, a novel method is required for eliminating a subtitle originally stored as a portion of an image of a video program.

### SUMMARY

It is therefore an objective of the claimed invention to provide a method for eliminating subtitles of a video program, and to provide an associated video display system, in order to solve the above-mentioned problems.

An exemplary embodiment of a method for eliminating subtitles of a video program is provided, where each of the subtitles is originally stored as a portion of an image of the video program. The method comprises: detecting whether a sub-region of a specific color exists within a predetermined region on the image, in order to determine whether a subtitle exists; and when it is detected that the subtitle exists, changing at least one color within the predetermined region to eliminate the subtitle.

An exemplary embodiment of an associated video display system comprises a processing circuit arranged to eliminate subtitles of a video program, wherein each of the subtitles is originally stored as a portion of an image of the video program. The processing circuit comprises a detection module and an elimination module. In addition, the detection module is arranged to detect whether a sub-region of a specific color exists within a predetermined region on the image, in order to determine whether a subtitle exists. Additionally, when it is detected that the subtitle exists, the elimination module changes at least one color within the predetermined region to eliminate the subtitle.

An exemplary embodiment of an associated video display system comprises a processing circuit arranged to eliminate subtitles of a video program, wherein each of the subtitles is originally stored as a portion of an image of the video program. The processing circuit comprises an elimination module arranged to change at least one color within a predetermined region on the image to eliminate any subtitle. In particular, the processing circuit further comprises a detection module arranged to selectively detect whether a sub-region of a specific color exists within the predetermined region, in order to determine whether the subtitle exists, and in a situation where the detection of the detection module is disabled, the elimination module changes the at least one color within the predetermined region to eliminate any subtitle.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a video display system according to a first embodiment of the present invention.

FIG. 2 is a flowchart of a method for eliminating subtitles of a video program according to one embodiment of the present invention.

FIGS. 3A-3B illustrate some implementation details of the processing circuit shown in FIG. 1 according to an embodiment of the present invention.

FIG. 4 is a diagram of a video display system according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

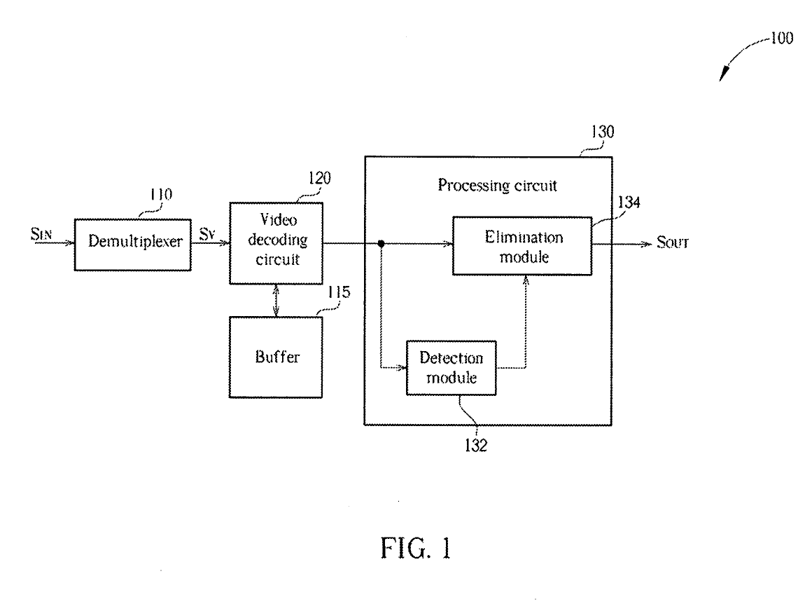

Please refer to FIG. 1, which illustrates a diagram of a video display system 100 according to a first embodiment of the present invention. As shown in FIG. 1, the video display system 100 comprises a demultiplexer 110, a buffer 115, a video decoding circuit 120, and a processing circuit 130, where the processing circuit 130 comprises a detection module 132 and an elimination module 134. In practice, the buffer 115 can be positioned outside the video decoding circuit 120. This is for illustrative purposes only, and is not meant to be a limitation of the present invention. According to a variation of this embodiment, the buffer 115 can be integrated into the video decoding circuit 120. According to another variation of this embodiment, the buffer 115 can be integrated into another component within the video display system 100.

In addition, the video display system 100 of this embodiment can be implemented as a digital television (TV) or a digital TV receiver, and comprises a digital tuner (not shown) for receiving broadcasting signals to generate a data stream such as a TV data stream S_{IN} of a video program. This is for illustrative purposes only, and is not meant to be a limitation of the present invention. According to a variation of this embodiment, the video display system 100 can be implemented as an analog TV or an analog TV receiver with the digital tuner mentioned above being replaced with an analog tuner, which is utilized for receiving broadcasting signals to generate a video data signal instead of the TV data stream S_{IN}. In this variation, the video decoding circuit 120 can be replaced by a pre-processing circuit in response to the differences between this variation and the first embodiment, where the demultiplexer 110 and a front stage within the pre-processing circuit can be implemented as analog components. For example, the video display system 100 of this variation may further comprise some other circuits arranged to generate an analog output signal instead of the output signal S_{OUT} shown in FIG. 1.

Please note that, according to this embodiment, the digital TV or the digital TV receiver mentioned above can be taken as an example of the video display system 100. This is for illustrative purposes only, and is not meant to be a limitation of the present invention. According to a variation of this embodiment, the video display system 100 can be implemented as an optical storage device such as a Digital Versatile Disc (DVD) player.

In this embodiment, the demultiplexer 110 is arranged to demultiplex the TV data stream S_{IN} into a video data stream S_{V} and an audio data stream S_{A} (not shown). The video decoding circuit 120 decodes the video data stream S_{V} to generate one or more images of the video program, where the buffer 115 is arranged to temporarily store the images of the video program. In addition, the processing circuit 130 is arranged to eliminate subtitles of the video program, and more particularly, the subtitles that are originally embedded in the images, where each of the subtitles is originally stored as a portion of an image of the video program. As a result, the processing circuit 130 generates the output signal S_{OUT} that carries the images without subtitles being respectively embedded therein. More specifically, the detection module 132 is arranged to detect whether a sub-region of a specific color exists within a predetermined region on the image, in order to determine whether a subtitle exists. When it is detected that the subtitle exists, the elimination module 134 can change at least one color within the predetermined region to eliminate the subtitle. For example, the detection module 132 can perform the detection all the way, and the elimination module 134 may operate in response to the detection of the detection module 132. This is for illustrative purposes only, and is not meant to be a limitation of the present invention. According to a variation of this embodiment, the detection module 132 is arranged to selectively detect whether a sub-region of a specific color exists within the predetermined region, in order to determine whether the subtitle exists.

More specifically, in this variation, the detection of the detection module 132 can be enabled/disabled based upon default settings or user settings. In a situation where the detection of the detection module is enabled, the elimination module 134 may operate in response to the detection of the detection module 132. In a situation where the detection of the detection module is disabled, the elimination module 134 can still change the at least one color within the predetermined region to eliminate any subtitle. For example, the elimination module 134 can blur the predetermined region to eliminate the subtitle. In another example, the elimination module 134 can fill the predetermined region with a predetermined color to eliminate the subtitle, where the predetermined color may represents a subtitle background color of the predetermined region.

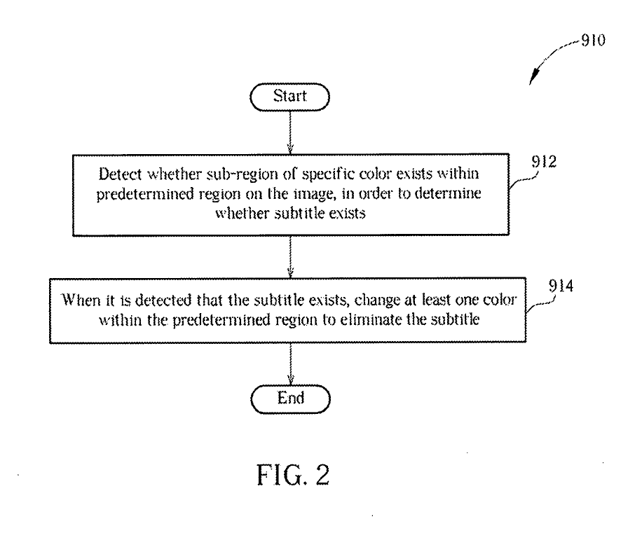

Based upon the architecture of the first embodiment or any of its variations disclosed above, the video display system 100 can properly eliminate any subtitle originally stored as a portion of the image of the video program. In a situation where eliminating the subtitles is required, the user can utilize a remote controller of the video display system 100 to disable subtitle display, and it really works, giving the user a good viewing experience. Some implementation details are further described according to FIG. 2.

FIG. 2 is a flowchart of a method 910 for eliminating subtitles of a video program according to one embodiment of the present invention. The method 910 shown in FIG. 2 can be applied to the video display system 100 shown in FIG. 1. The method is described as follows.

In Step 912, the detection module 132 detects whether a sub-region of a specific color exists within a predetermined region on the image, in order to determine whether a subtitle exists. For example, in a first mode of the detection module 132, the specific color may represent the subtitle background color of the predetermined region, and the specific color is a predetermined color such as that mentioned above. In another example, in a second mode of the detection module 132, the specific color may represent a color of a stroke of the subtitle, and the sub-region comprises at least one bar, such as one or more bars respectively corresponding to one or more strokes of the subtitle.

In Step 914, when it is detected that the subtitle exists, the elimination module 134 changes at least one color within the predetermined region to eliminate the subtitle. For example, the elimination module 134 may operate in response to the detection corresponding to the first mode of the detection module 132. In another example, the elimination module 134 may operate in response to the detection corresponding to the second mode of the detection module 132.

Regarding the first mode of the detection module 132, the implementation details thereof are described as follows. According to this embodiment, in a situation where the specific color represents the subtitle background color of the predetermined region (e.g. the subtitle background color is typically black), when it is detected that the subtitle exists, the elimination module 134 fills the predetermined region with the specific color to eliminate the subtitle. For example, suppose that the specific color such as the subtitle background color is black and the predetermined region is a rectangular region at the bottom of the image, and the detection module 132 can detect whether four sub-regions around the four corners of the rectangular region are black to determine whether the subtitle exists in the predetermined region. When it is detected that the four sub-regions around the four corners of the rectangular region are black, the detection module 132 determines that the subtitle exists in the predetermined region. Then, the elimination module 134 fills the predetermined region with black, in order to eliminate the subtitle. This is for illustrative purposes only, and is not meant to be a limitation of the present invention. According to a variation of this embodiment, when it is detected that the subtitle exists, the elimination module 134 changes at least one color of the subtitle to be the aforementioned specific color (e.g. the subtitle background color such as black) to eliminate the subtitle, rather than forcibly filling the whole of the predetermined region with the specific color.

Regarding the second mode of the detection module 132, the implementation details thereof are described as follows. As mentioned, in the second mode, the sub-region comprises at least one bar, such as one or more bars respectively corresponding to one or more strokes of at least one character/word of the subtitle, where the bars represent the sub-regions that are occupied by the strokes. According to this embodiment, in a situation where the specific color represents the color of the stroke of the subtitle, when it is detected that the subtitle exists, the elimination module 134 fills the sub-region with a color of at least one pixel outside the at least one bar to eliminate the subtitle. For example, suppose that the specific color such as the stroke color is yellow and the predetermined region is a rectangular region at the bottom of the image, and the detection module 132 can detect whether there are yellow bars around the center of the rectangular region to determine whether the subtitle exists in the predetermined region. When it is detected that there are yellow bars around the center of the rectangular region, the detection module 132 determines that the subtitle exists in the predetermined region. Then, the elimination module 134 fills the predetermined region with the colors of the pixels outside the bars, and more particularly, with the respective colors of the neighboring pixels outside the bars, in order to eliminate the subtitle. This is for illustrative purposes only, and is not meant to be a limitation of the present invention. According to a variation of this embodiment, when it is detected that the subtitle exists, the elimination module 134 fills the sub-region with a color mixed from at least one color of a plurality of pixels respectively positioned at different sides of the aforementioned at least one bar to eliminate the subtitle.

Please note that the specific color mentioned in Step 912 can be unknown at first. In practice, the detection module 132 of this embodiment may detect the specific color, and further notify the elimination module 134 of what the specific color is, so the elimination module 134 may operate accordingly. For example, regarding the first mode, in a situation where it is detected that the four sub-region around the four corners of the rectangular region are of a same color, the detection module 132 can determine the specific color mentioned in Step 912 to be this color. In another example, regarding the second mode, in a situation where it is detected that the aforementioned at least one bar of a same color exists, the detection module 132 can determine the specific color mentioned in Step 912 to be this color in the at least one bar.

According to this embodiment, the first and the second modes of the detection module 132 are involved. This is for illustrative purposes only, and is not meant to be a limitation of the present invention. According to a variation of this embodiment, more than two modes of the detection module 132 can be implemented when needed. For example, in a third mode of the detection module 132, the detection module 132 may compare the aforementioned at least one bar with one or more predetermined stroke patterns, in order to determine whether the subtitle exists in the predetermined region, where the predetermined stroke patterns may represent at least one portion of a plurality of characters (e.g. a portion or all of the plurality of characters) or represent at least one portion of a single character (e.g. a portion or the whole of the single character). According to another variation of this embodiment, in a fourth mode of the detection module 132, the detection module 132 performs operations that are combined from those of the second and the third modes, in order to achieve a better detection result, where the processing circuit 130 can be equipped with better computation ability.

According to this embodiment, the predetermined region can be rectangular and can be positioned at the bottom of the image. This is for illustrative purposes only, and is not meant to be a limitation of the present invention. According to a variation of this embodiment, the predetermined region can be non-rectangular. According to another variation of this embodiment, the predetermined region can be positioned somewhere else within the image, rather than the bottom of the image.

According to this embodiment, the subtitle elimination operations associated to Step 914 can be automatically triggered by the detection of the detection module 132, based upon user settings and/or default settings. This is for illustrative purposes only, and is not meant to be a limitation of the present invention. According to a variation of this embodiment, the subtitle elimination operations associated to Step 914 can be triggered manually, based upon user settings and/or default settings.

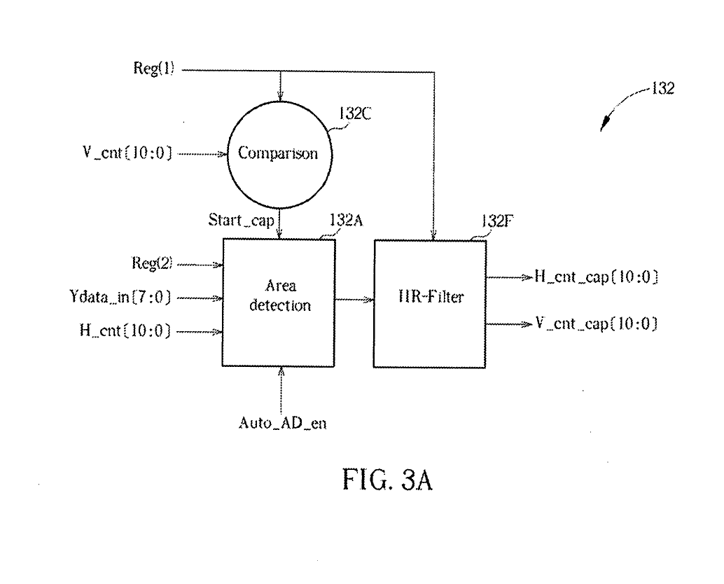

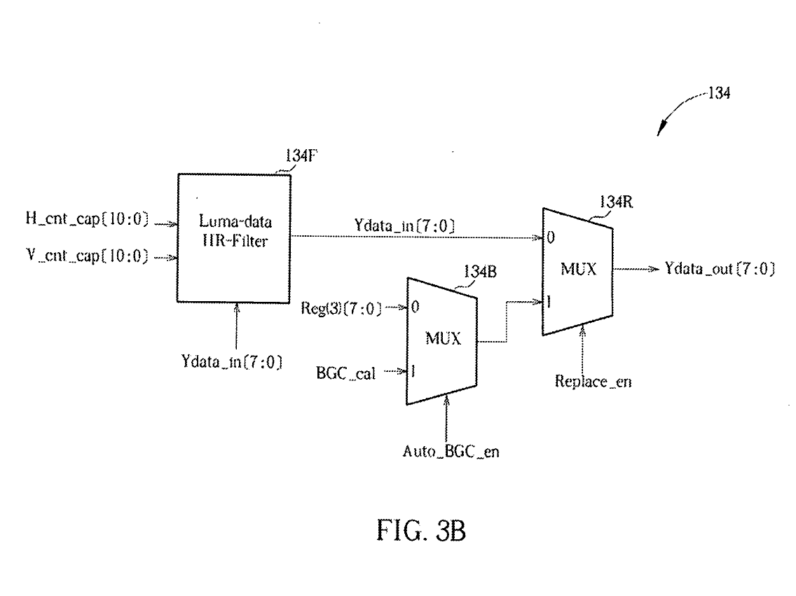

FIGS. 3A-3B illustrate some implementation details of the processing circuit shown in FIG. 1 according to an embodiment of the present invention. In this embodiment, the detection module 132 comprises a comparison unit 132C (labeled “Comparison” in FIG. 3A), an area detection unit 132A (labeled “Area detection” in FIG. 3A), and an IIR-filter 132F, and the elimination module 134 comprises a Luma-data IIR-filter 134F and two multiplexers 134B and 134R (labeled “MUX” in FIG. 3B).

The notations Reg(1) and Reg(2) shown in FIG. 3A and the notation Reg(3)[7:0] shown in FIG. 3B represent register values, and the notations Ydata_in[7:0] and Ydata_out[7:0] represent the luminance component of the input data of the processing circuit 130 and the luminance component of the output data of the processing circuit 130, respectively. In addition, the notations V_cnt[10:0] and H_cnt[ 10:0] respectively represent vertical and horizontal locations within the image, where “V_cnt” stands for vertical count, and “H_cnt” stands for horizontal count. Additionally, the notations V_cnt_cap[10:0] and H_cnt_cap[10:0] represent vertical and horizontal locations within the predetermined region, respectively.

Referring to FIG. 3A, the comparison unit 132C compares the vertical location V_cnt[10:0] with the register value Reg(1) to generate an indication signal Start_cap, and utilize the indication signal Start_cap to notify the area detection unit 132A of whether to start/stop performing area detection. For example, the area detection unit 132A can perform the area detection when the vertical location V_cnt[10:0] reaches the register value Reg(1). Please note that there is an automatic area detection enabling signal Auto_AD_en arranged to notify the area detection unit 132A of whether to perform the area detection in an automatic mode or a manual mode. In addition, the register value Reg(2) defines the ratio of the height of the predetermined region to the height of the image. For example, when the register value Reg(2) is equal to ¼, it restricts the predetermined region to have the height equivalent to ¼ of the height of the image. In another example, when the register value Reg(2) is equal to ⅙, it restricts the predetermined region to have the height equivalent to ⅙ of the height of the image. As a result, the area detection unit 132A detects the predetermined region, and inputs the luminance component Ydata_in[7:0] into the IIR-filter 132F when the current value of the vertical location V_cnt[10:0] and the current value of the horizontal location H_cnt[10:0] indicate that a current pixel under consideration is within the predetermined region. Additionally, the IIR-filter 132F performs filtering on the luminance component Ydata_in[7:0] to compare the luminance component Ydata_in[7:0] with a pre-set value that represents the luminance component of the aforementioned predetermined color such as the subtitle background color, in order to prevent from determining the predetermined region as an incorrect area covering non-subtitle video contents of the image. For example, in a situation where the subtitle background color is black, the IIR-filter 132F may compare the luminance component Ydata_in[7:0] with zero. Based upon the architecture disclosed above, the vertical location V_cnt_cap[10:0] and the horizontal location H_cnt_cap[10:0] restricts the predetermined region to be a correct area that does not cover any non-subtitle video content of the image.

Referring to FIG. 3B, the Luma-data IIR-filter 134F performs filtering on the luminance component Ydata_in[7:0]. By utilizing the Luma-data IIR-filter 134F and the multiplexers 134R and 134B, the elimination module 134 replaces the original color within the predetermined region by the aforementioned predetermined color such as the subtitle background color, where the predetermined region is restricted by the vertical location V_cnt_cap[10:0] and the horizontal location H_cnt_cap[10:0]. Please note that a control unit (not shown in FIG. 3B) within the elimination module 134 is arranged to generate a replacement enabling signal Replace_en and a calculated background color BGC_cal. Under control of the replacement enabling signal Replace_en, the multiplexer 134R dynamically selects the luminance component Ydata_in[7:0] or the predetermined color such as the output of the multiplexer 134B as the luminance component Ydata_out[7:0]. For example, the replacement enabling signal Replace_en can be in an enabling state when the pixel under consideration is within the predetermined region, and can be in a disabling state when the pixel under consideration is outside the predetermined region. In another example, the replacement enabling signal Replace_en may dynamically switch between the enabling state and the disabling state when the pixel under consideration is within the predetermined region, and can be in a disabling state when the pixel under consideration is outside the predetermined region, where the replacement enabling signal Replace_en can be sensitive to the stroke of the subtitle. In addition, under control of an automatic background color enabling signal Auto_BGC_en, the multiplexer 134R selects the pre-set color defined by the register value Reg(3) or selects the calculated background color BGC_cal, where the calculated background color BGC_cal represents the background color automatically detected from the image. Similar descriptions for this embodiment are not repeated in detail.

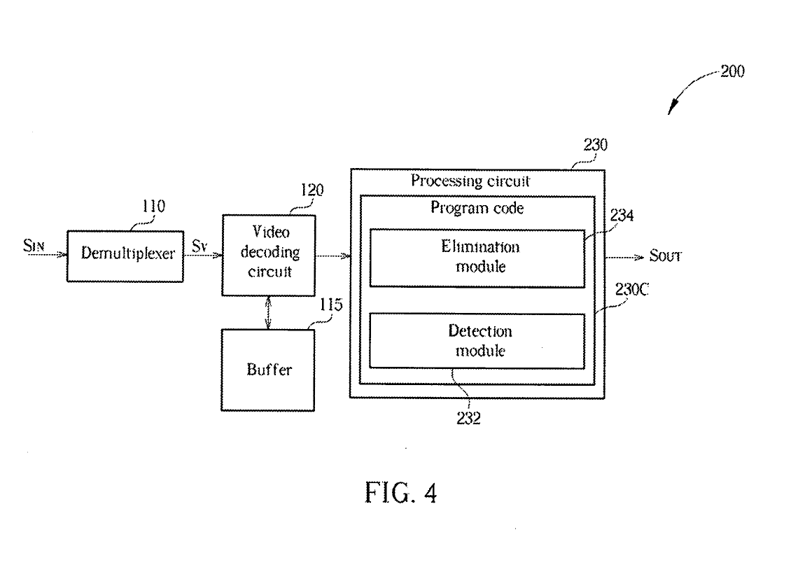

FIG. 4 is a diagram of a video display system 200 according to a second embodiment of the present invention. The differences between the first and the second embodiments are described as follows.

The processing circuit 130 mentioned above is replaced by a processing circuit 230 executing program code 230C, where the program code 230C comprises program modules such as a detection module 232 and an elimination module 234 respectively corresponding to the detection module 132 and the elimination module 134. In practice, the processing circuit 230 executing the detection module 232 typically performs the same operations as those of the detection module 132, and the processing circuit 230 executing the elimination module 234 typically performs the same operations as those of the elimination module 134, where the detection module 232 and the elimination module 234 can be regarded as the associated software/firmware representatives of the detection module 132 and the elimination module 134, respectively. Similar descriptions for this embodiment are not repeated in detail.

It is an advantage of the present invention that, based upon the architecture of the embodiments/variations disclosed above, the goal of eliminating any subtitle originally stored as a portion of the image of the video program can be achieved. In a situation where eliminating the subtitles is required, the user can utilize the remote controller of the video display system or a button positioned on the video display system to disable subtitle display with ease, and the related art problems can no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

1. A method for eliminating subtitles of a video program, each of the subtitles being originally stored as a portion of an image of the video program, the method comprising:
detecting whether a sub-region of a specific color exists within a predetermined region on the image, in order to determine whether a subtitle exists; and
when it is detected that the subtitle exists, changing at least one color within the predetermined region to eliminate the subtitle.

2. The method of claim 1, wherein the specific color represents a subtitle background color of the predetermined region; and the specific color is a predetermined color.

3. The method of claim 2, wherein the step of changing the at least one color within the predetermined region to eliminate the subtitle further comprises:
when it is detected that the subtitle exists, filling the predetermined region with the specific color to eliminate the subtitle.

4. The method of claim 2, wherein the step of changing the at least one color within the predetermined region to eliminate the subtitle further comprises:
when it is detected that the subtitle exists, changing at least one color of the subtitle to be the specific color to eliminate the subtitle.

5. The method of claim 2, wherein the predetermined color is black.

6. The method of claim 1, wherein the specific color represents a color of a stroke of the subtitle; and the sub-region comprises at least one bar.

7. The method of claim 6, wherein the step of changing the at least one color within the predetermined region to eliminate the subtitle further comprises:
when it is detected that the subtitle exists, filling the sub-region with a color of at least one pixel outside the at least one bar to eliminate the subtitle.

8. The method of claim 6, wherein the step of changing the at least one color within the predetermined region to eliminate the subtitle further comprises:
when it is detected that the subtitle exists, filling the sub-region with a color mixed from at least one color of a plurality of pixels respectively positioned at different sides of the bar to eliminate the subtitle.

9. The method of claim 1, wherein the predetermined region is positioned at the bottom of the image.

10. The method of claim 1, wherein the predetermined region is rectangular.

11. A video display system, comprising:
a processing circuit arranged to eliminate subtitles of a video program, wherein each of the subtitles is originally stored as a portion of an image of the video program, and the processing circuit comprises:
a detection module arranged to detect whether a sub-region of a specific color exists within a predetermined region on the image, in order to determine whether a subtitle exists; and
an elimination module, wherein when it is detected that the subtitle exists, the elimination module changes at least one color within the predetermined region to eliminate the subtitle.

12. The video display system of claim 11, wherein the specific color represents a subtitle background color of the predetermined region; and the specific color is a predetermined color.

13. The video display system of claim 12, wherein when it is detected that the subtitle exists, the elimination module fills the predetermined region with the specific color to eliminate the subtitle.

14. The video display system of claim 12, wherein when it is detected that the subtitle exists, the elimination module changes at least one color of the subtitle to be the specific color to eliminate the subtitle.

15. The video display system of claim 12, wherein the predetermined color is black.

16. The video display system of claim 11, wherein the specific color represents a color of a stroke of the subtitle; and the sub-region comprises at least one bar.

17. The video display system of claim 16, wherein when it is detected that the subtitle exists, the elimination module fills the sub-region with a color of at least one pixel outside the at least one bar to eliminate the subtitle.

18. The video display system of claim 16, wherein when it is detected that the subtitle exists, the elimination module fills the sub-region with a color mixed from at least one color of a plurality of pixels respectively positioned at different sides of the bar to eliminate the subtitle.

19. The video display system of claim 11, wherein the predetermined region is positioned at the bottom of the image.

20. The video display system of claim 11, wherein the predetermined region is rectangular.

21. A video display system, comprising:
a processing circuit arranged to eliminate subtitles of a video program, wherein each of the subtitles is originally stored as a portion of an image of the video program, and the processing circuit comprises:
an elimination module arranged to change at least one color within a predetermined region on the image to eliminate any subtitle.

22. The video display system of claim 21, wherein the processing circuit further comprises:
a detection module arranged to selectively detect whether a sub-region of a specific color exists within the predetermined region, in order to determine whether the subtitle exists;
wherein in a situation where the detection of the detection module is disabled, the elimination module changes the at least one color within the predetermined region to eliminate any subtitle.

23. The video display system of claim 21, wherein the elimination module blurs the predetermined region to eliminate the subtitle.

24. The video display system of claim 21, wherein the elimination module fills the predetermined region with a predetermined color to eliminate the subtitle.
